(19) United States
(12) Patent Application Publication
(10) Pub. No.: US 2026/0153221 A1
(43) Pub. Date: Jun. 4, 2026

(54) LIGHTING DEVICE WITH SIDE LIT REFLECTOR

(71) Applicant: SIGNIFY HOLDING B.V., EINDHOVEN (NL)

(72) Inventors: EDUARDO NAVA PALOMARES, General Escobe (MX); Raymond Thomas Zavesky, Hudson, MA (US); Nathanael Alden Greene, Mystic, CT (US); Kevin Lynn Tackitt, Tupelo, MS (US)

(21) Appl. No.: 19/406,036

(22) Filed: Dec. 2, 2025

Related U.S. Application Data
(60) Provisional application No. 63/727,588, filed on Dec. 3, 2024.

(30) Foreign Application Priority Data
Dec. 13, 2024 (EP) 24219766.3

(51) Int. Cl. F21V 7/00; F21V 7/07; F21V 15/015; F21V 23/04; F21Y 115/10

(52) U.S. Cl. CPC F21V 7/0008; F21V 7/0041; F21V 7/0066; F21V 7/07; F21V 15/015; F21V 23/0471; F21Y 2115/10

(57) ABSTRACT

A lighting device includes a reflector that includes a reflector wall surrounding a reflector cavity. The reflector wall has a reflective outer surface. The reflector wall extends between a top opening of the reflector and a bottom opening of the reflector, where the bottom opening is smaller than the top opening. The lighting device further includes a light source board that includes light sources, where the light source board is positioned around the reflector. The light source board is oriented such that the light sources emit lights toward the reflective outer surface. The reflector wall is shaped such that the reflective outer surface reflects the lights downwardly away from the light source board.

### TECHNICAL FIELD

The present disclosure relates generally to lighting and related solutions, and in particular to side lit reflectors and lighting devices with a side lit reflector.

### BACKGROUND

Some light fixtures that are installed recessed in a ceiling may include reflectors. Some surface mounted light fixtures that are mounted to a ceiling may also have reflectors. Such light fixtures that include a reflector often have a light source that is positioned above the reflector or in the cavity of the reflector. When the light source is positioned above reflector, the light emitted by the light source enters the cavity of the reflector through a narrow opening of the reflector and some of the light exits directly through a wide opening of the reflector while some of the light is reflected by the inner surface of the reflector before exiting the cavity of the reflector. When the light source is positioned in the cavity of the reflector, some of the light emitted by the light source may exit the reflector directly through the wide opening of the reflector while some of the light is reflected by the inner surface of the reflector before exiting the cavity of the reflector. The light source of such light fixtures can be visible from directly below such light fixtures and can result in excessive glare unless deeply recessed behind the ceiling or covered by a diffuser. Due to restrictions in available space behind the ceiling in many applications, these deeply recessed fixtures are not always an option, and the use of diffusers can be aesthetically undesirable in many applications. Thus, a solution that provides a shallow reflector solution while eliminating or reducing the dominance of diffusers of light fixtures may be desirable.

### SUMMARY

The present disclosure relates generally to lighting and related solutions, and in particular to side lit reflectors and lighting devices with a side lit reflector. In an example embodiment, a lighting device includes a reflector that includes a reflector wall surrounding a reflector cavity. The reflector wall has a reflective outer surface. The reflector wall extends between a top opening of the reflector and a bottom opening of the reflector, where the bottom opening is smaller than the top opening. The lighting device further includes a light source board that includes light sources, where the light source board is positioned around the reflector. The light source board is oriented such that the light sources emit lights toward the reflective outer surface. The reflector wall is shaped such that the reflective outer surface reflects the lights downwardly away from the light source board.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a lighting device having a reflector according to an example embodiment;

FIG. 2 illustrates A-A cross-section of the lighting device of FIG. 1 according to an example embodiment;

FIG. 3 illustrates the housing frame of the lighting device of FIG. 1 according to an example embodiment;

FIGS. 4A-4C illustrate different views of an assembly of the reflector and the light source board of the lighting device of FIG. 1 according to an example embodiment;

FIG. 5 illustrates B-B cross-section of the assembly of the reflector and the light source board shown in FIG. 4A according to an example embodiment;

FIGS. 6A and 6B illustrate different views of the reflector of the lighting device of FIG. 1 according to an example embodiment;

FIG. 7 illustrates a sensor device attached to the light device of FIG. 1 according to an example embodiment;

FIGS. 8A and 8B illustrate different cross-sectional views of the lighting device of FIG. 7 including the sensor device according to an example embodiment;

FIG. 9 illustrates a cross-sectional view of an assembly of a reflector and light source boards for use in the lighting device of FIG. 1 according to an example embodiment;

FIG. 10 illustrates a lighting device having a reflector according to another example embodiment; and

FIG. 11 illustrates a cross-sectional view of an assembly of a reflector and a light source board of the lighting device of FIG. 10 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the figures, the same reference numerals used in different figures may designate like or corresponding and not necessarily identical elements.

### DETAILED DESCRIPTION OF THE EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

Turning now to the drawings, example embodiments are described. FIG. 1 illustrates a lighting device 100 having a reflector 102 according to an example embodiment. For example, the lighting device 100 may be a surface mounted light fixture or a recessed light fixture. To illustrate, the lighting device 100 may be mounted to or recessed in a ceiling. In some example embodiments, the lighting device 100 may include the reflector 102, a housing frame 104, and a housing cover 106. The reflector 102 may include a reflector wall 108 having a reflective outer surface 122. The reflector 102 may also include attachment tabs 110, 112, 114 that extend through respective attachment slots of the housing cover 106 to attach the reflector 102 to the housing cover 106. The attachment tabs 110, 112, 114 may extend up from the reflector wall 108. For example, the attachment tab 110 that extends up from the reflector 102 is positioned through an attachment slot 116 of the housing cover 106. The attachment tab 112 may extend through another attachment slot of the housing cover 106, and the attachment tab 114 may extend through yet another attachment slot of the housing cover 106. To securely attach the reflector 102 to the housing cover 106, the attachment tabs 110, 112, 114 may also be bent down, for example, onto the housing cover 106. In addition to attaching the reflector 102 to the housing cover 106, the attachment tabs 110, 112, 114 may prevent the rotation of the reflector 102 after attachment to the housing cover 106.

In some example embodiments, the housing cover 106 may include a wire routing opening 120 that may be used to route an electrical cable 118 (e.g., one or more electrical wires) to the light source board of the lighting device 100. For example, a power supply (e.g., a light emitting diode (LED) driver) may be positioned on the housing cover 106 and may be wired to the electrical cable 118. For example, an LED driver (not shown) may be attached to the housing cover 106 by fasteners. In some cases, a junction box (not shown) may be attached to the housing cover 106, and a power supply may be placed inside the junction box.

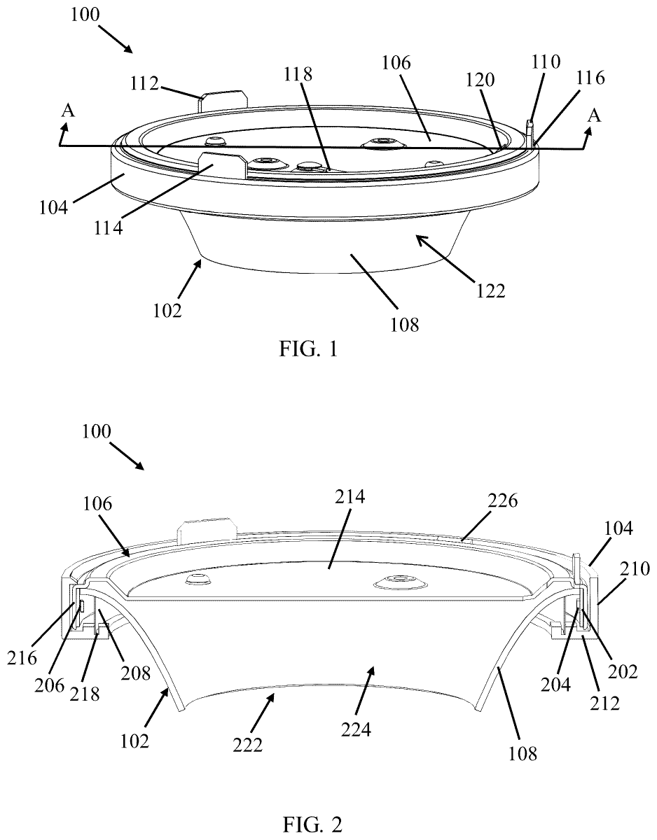

FIG. 2 illustrates A-A cross-section of the lighting device 100 of FIG. 1 according to an example embodiment. Referring to FIGS. 1 and 2, in some example embodiments, the reflector 102 may have a reflector cavity 224 that is surrounded by the reflector wall 108. The reflector 102 may have a top opening and a bottom opening 222 that are connected to the reflector cavity 224. The housing cover 106 may be positioned such that the housing cover 106 closes off the top opening of the reflector 102. For example, the housing cover 106 may include a cover section 214 and a skirt section 216. The skirt section 216 may extend down from the cover section 214. The housing cover 106 may be positioned such that the cover section 216 covers the top opening of the reflector 102.

In some example embodiments, the housing frame 104 may include a wall section 210 and a base section 212. The housing frame 104 may have an enclosed shape such as a round shape. The housing frame 104 may be positioned around the reflector 102 such that the base section 212 extends from the wall section 210 toward the reflector 102. For example, the wall section 210 of the housing frame 104 may be around the skirt section 216 of the housing cover 106, where the skirt section 216 extends down from the cover section 214 of the housing cover 106 between the wall section 210 and the reflector 102. The base section 212 of the housing frame 104 may extend from the wall section 210 toward the reflector 102 such that the skirt section 216 is positioned on the base section 212.

In some example embodiments, the housing frame 104 may include retention tabs, such as a retention tab 226, that protrude inwardly from the wall section 210 toward the center of the housing frame 104 and above the housing cover 106. The retention tabs may retain the housing cover 106 attached to the housing frame 104 by preventing unintended upward movement of the housing cover 106. To illustrate, the retention tabs of the housing frame 104 may retain the skirt section 216 of the housing cover 106 on the base section 212 of the housing frame 104.

In some example embodiments, the lighting device 100 includes a light source board 202. The light source board 202 may include light sources 204, 206 as well as other light sources. For example, the light source board 202 may be an LED board that includes a printed circuit board (e.g., a rigid printed circuit board or a flexible printed circuit board) and LEDs attached to the printed circuit board. To illustrate, the light sources 204, 206 may each be an LED light source that is attached to the printed circuit board of the light source board 202.

In some example embodiments, the light source board 202 is positioned around the reflector 102. For example, the light source board 202 may be positioned proximal to the top opening of the reflector 102. The light source board 202 may be oriented such that the light sources of the light source board 202, including the light sources 204, 206, emit lights toward the reflective outer surface 122 of the reflector wall 108. As such, the reflector 102 is a side lit reflector. The light provided by the lighting device 100 is a combination of the lights emitted by the light sources of the light source board 202.

In some example embodiments, the wall section 210 of the housing frame 104 may be positioned around the light source board 202 such that the skirt section 216 of the top cover 106 is positioned between the wall section 210 and the light source board 202. To illustrate, the light source board 202 may be attached to the skirt section 216 of the top cover 106, where the light sources 204, 206 as well as other light sources of the light source board 202 are positioned to emit lights toward the reflective outer surface 122 of the reflector wall 108. That is, the skirt section 216 may be positioned around the light source board 202 such that the light source board 202 is attached to the skirt section 216. The light source board 202 may be attached to the skirt section 216 using an adhesive and/or fasteners. The base section 212 of the housing frame 104 may extend from the wall section 210 toward the reflector 102 such that the base section 212 hides the light sources, including the light sources 204, 206, from view from directly below the light sources.

In some example embodiments, the reflector wall 108 may be shaped such that the reflective outer surface 122 reflects the lights emitted by the light sources of the light source board 202 downwardly away from the light source board 202. For example, the reflector wall 108 may extend between the top opening of the reflector 102 and the bottom opening 222 of the reflector 102, where the bottom opening 222 is smaller (e.g., a smaller diameter) than the top opening. To illustrate, the reflector wall 108 may have a curved shape between the top opening of the reflector 102 and the bottom opening 222 of the reflector 102.

In some example embodiments, the lighting device 100 may include a lens 208 that is positioned vertically or substantially vertically between the base section 21 of the housing frame 104 and the reflector wall 108. For example, the base section 212 may include a channel 218, and the lens 208 may be positioned in the channel 218 that helps retain the lens 208 in position. To illustrate, an edge of the lens 208 may be in the channel 218 and an opposite edge of the lens 208 may be in contact with the reflector wall 108. The lens 208 may be positioned such that the lights provided by the light source board 202 mostly pass through lens 208 before reaching the reflective outer surface 122 of the reflector wall 108 that reflects down the lights.

In some example embodiments, the reflector 102 may be made from a metal, such as aluminum, using one or more methods such as spinning, bending, cutting, etc. The reflector 102 may be painted with a reflective color (e.g., white) such that the reflective outer surface 122 of the reflector wall 108 efficiently reflects the light from the light source board 202. Alternatively, the reflector 102 may be made from another material, such as plastic, using one more or more methods such as injection molding. For example, the reflector 102 may be made from white plastic. The housing frame 104 may be made from one or more materials such as plastic using one or more methods such as injection molding. The housing cover 106 may be made from one or more materials such as plastic using one or more methods such as injection molding. Alternatively, the housing cover 106 may be made from a metal such as aluminum using one or more methods such as cutting, bending, etc.

The lighting device 100 may be installed as a downlight light fixture. For example, the lighting device 100 may be installed as a surface mounted light fixture or a recessed light fixture. The lighting device 100 allows for the light source board 202 to be positioned to eliminate or minimize glare. Because the top opening of the reflector 102 may be larger than the bottom opening 222 of the reflector 102, the lighting device 100 allows for flexibility for controlling the number and relative positioning of the light sources of the light source board 202 to control lighting pattern, light intensity, etc.

In some alternative embodiments, the lighting device 100 may have a different shape than shown without departing from the scope of this disclosure. For example, the housing frame 104 may have a different shape than shown. To illustrate, the housing frame 104 may have a rectangular shape instead of a round shape. In some example embodiments, the reflector wall 108 may have a different shape than shown without departing from the scope of this disclosure. For example, the reflector wall 108 may be curved more or less than shown. As another example, the reflector wall 108 may not be curved. In some alternative embodiments, the light source board 202 may be angled toward or away from the reflector wall 108 without departing from the scope of this disclosure. In some alternative embodiments, the light source board 202 may be at a different location (e.g., lower) than shown in FIG. 2 without departing from the scope of this disclosure. In some alternative embodiments, the lens 208 may be omitted without departing from the scope of this disclosure. In some alternative embodiments, the lens 208 may be slanted toward or away from the light source board 202 without departing from the scope of this disclosure. In some alternative embodiments, the lighting device 100 may include other components such as a driver and/or mounting structures that may be used to mount the lighting device 100, for example, recessed in a ceiling.

FIG. 3 illustrates the housing frame 104 of the lighting device 100 of FIG. 1 according to an example embodiment. Referring to FIGS. 1-3, in some example embodiments, the housing frame 104 includes the wall section 210 and the base section 212 and may enclose an enclosed area 302. For example, the housing frame 104 may have a round shape that encloses the enclosed area 302. During the assembly of the lighting device 100, the reflector 102 may be inserted through the enclosed area 302 such that the bottom opening 222 of the reflector 102 is below the housing frame 104 and such that the top opening of the reflector 102 is above the housing frame 104. After the lens 208 is positioned in the channel 218, and the housing cover 106 may be placed on the base section 212 of the housing cover 106 with the light source board 202 already attached to the skirt section 216.

In some example embodiments, the housing frame 104 may include retention tabs 226, 304 as well as one or more other retention tabs. For example, after the housing cover 106 is attached to housing frame 104 where the skirt section 216 is positioned on the base section 212, the retention tabs 226, 304 may retain the housing cover 106 attached to the housing frame 104. positioned around the reflector 102 such that the base section 212 extends from the wall section 210 toward the reflector 102. For example, the wall section 210 of the housing frame 104 may be around the skirt section 216 of the housing cover 106, where the skirt section 216 extends down from the cover section 214 of the housing cover 106 between the wall section 210 and the reflector 102. The base section 212 of the housing frame 104 may extend from the wall section 210 toward the reflector 102 such that the skirt section 216 is positioned on the base section 212.

In some example embodiments, the housing frame 104 includes the channel 218 that is formed in the base section 212 of the housing frame 104. The lens 208 may be positioned such that an edge of the lens 208 is in the channel 218 that may retain the lens 208 in position.

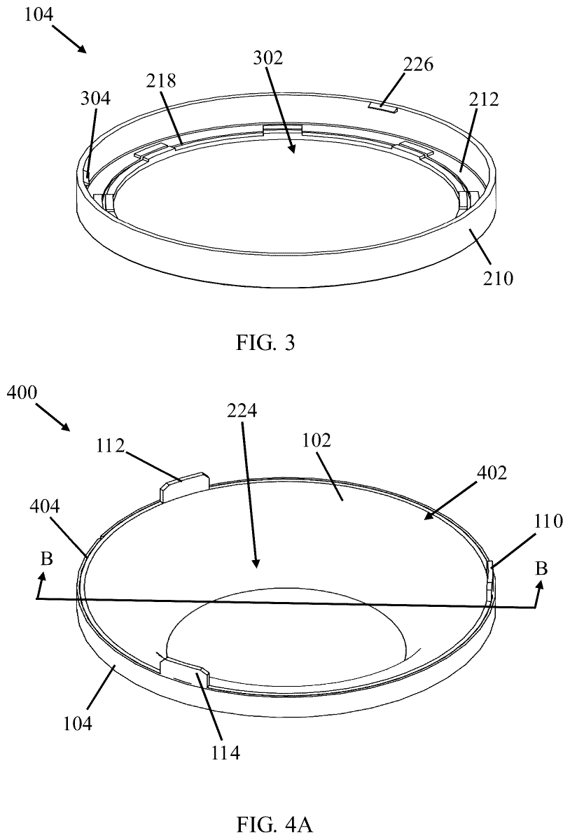

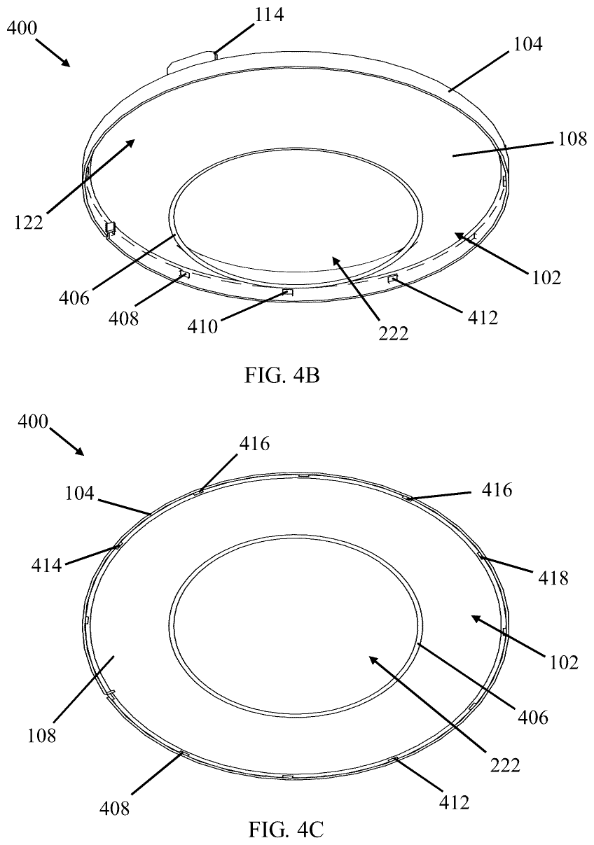

FIGS. 4A-4C illustrate different views of an assembly 400 of the reflector 102 and the light source board 202 of the lighting device 100 of FIG. 1 according to an example embodiment, and FIG. 5 illustrates a B-B cross-section of the assembly 400 of the reflector and the light source board shown in FIG. 4A according to an example embodiment. As described above, in some example embodiments, the reflector 102 may include the attachment tabs 110, 112, 114 that extend up from the reflector wall 108. The attachment tabs 110, 112, 114 may be positioned to be inserted in respective attachment slots of the housing cover 106 to attach the reflector 102 to the housing cover 106.

In some example embodiments, the light source board 202 is positioned around the reflector 102 proximal to the top opening 402 of the reflector 102. For example, the light source board 202 may be positioned abutted against a perimeter edge 404 of the reflector wall 108 at the top opening 402 of the reflector 102. For example, the light source board 202 may be attached to the perimeter edge 404 by an adhesive or another means. In some alternative embodiments, the reflector 102 may have a skirt that extends down at the perimeter edge 404 around the reflector wall 108, and the light source board 202 may be attached to skirt, instead of the skirt section 216 of the housing cover 106, to provide lights that are reflected by the reflective outer surface 122 of the reflector wall 108.

In some example embodiments, the light source board 202 may include light sources 204, 206, 408, 410, 412, 414, 416, 418 as well as other light sources that may be positioned around the reflector wall 108. For example, the light sources of the light source board 202 may be LED light sources that are attached to the printed circuit board of the light source board 202. The light sources of the light source board 202 may be positioned around the reflector 102 to emit lights toward the reflective outer surface 122 of the reflector wall 108. For example, the light sources of the light source board 202 may be positioned to provide a uniform light around the reflector wall 108. The light source board 202 may be designed to have a particular number of the light sources of the light source board 202 that are positioned relative to each other to produce a desired light intensity and/or pattern.

In some example embodiments, the reflector wall 108 is curved as the reflector wall 108 extends between the perimeter edge 404 of the reflector wall 108 at the top opening 402 of the reflector and the perimeter edge 406 of the reflector wall 108 at the bottom opening 222 of the reflector 102. The light source board 202 may be positioned around the reflector 102 proximal to the top opening 402 of the reflector 102 such that the lights provided by the light source board 202 are reflected downwardly by the reflective outer surface 122. As more clearly shown in FIG. 5, lights emitted by the light sources, such as the light sources 204, 206, of the light source board 202 are emitted toward the reflector wall 18, that reflects the lights downwardly. The lights emitted by the light sources 204, 206 are illustratively shown in FIG. 5 as dotted arrows. Because the bottom opening 222 is smaller in dimension than the top opening 402, the lights emitted by the light sources of the light source board 202 can be reflected downwardly by the reflector 102, for example, to illuminate an area below the reflector 102. As such, the lighting device 100 can be used as a downlight light fixture. Because the light source board 202 is positioned the around the reflector 102, the lights provided the light source board 202 do not pass through the reflector cavity 224 and thus are not limited by the size of the bottom opening 222. Because the light source board 202 is positioned around the reflector 102 proximal to the top opening 402 that is larger than the bottom opening 222, the number of light sources of the light source board 202 may not be limited by the size of the bottom opening 222.

In some alternative embodiments, the light sources of the lighting device 100, including the light sources 204, 206, 408, 410, 412, 414, 416, 418, may be positioned in a different pattern than shown without departing from the scope of this disclosure. In some alternative embodiments, the lighting device 100 may include fewer or more light sources than shown without departing from the scope of this disclosure.

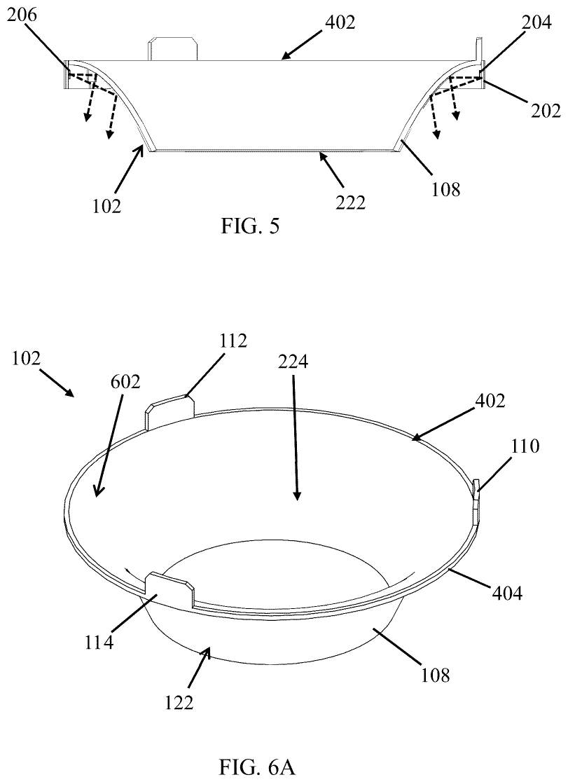

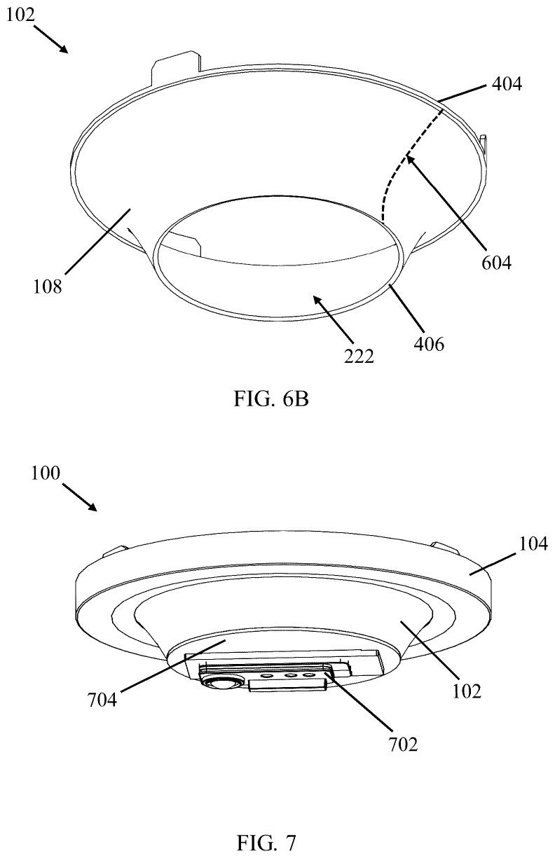

FIGS. 6A and 6B illustrate different views of the reflector 102 of the lighting device 100 of FIG. 1 according to an example embodiment. In some example embodiments, the reflector 102 includes the reflector wall 108 that may have the reflective outer surface 122 facing outwardly from the reflector 102 and an inner surface 602 on the side of the reflector cavity 224. The inner surface 602 may be a reflective or non-reflective surface.

In some example embodiments, the reflector wall 108 may have a curved shape as the reflector wall 108 extends between the perimeter edge 404 of the reflector wall 108 at the top opening 402 and the perimeter edge 406 of the reflector wall 108 at the bottom opening 222. For example, the dotted virtual line 604 illustrates the curved shape of the reflector wall 108 between the perimeter edges 404, 406.

In some alternative embodiments, the attachment tabs 110, 112, 114 may be at different locations than shown without departing from the scope of this disclosure. In some alternative embodiments, the reflector 102 may include more or fewer attachment tabs than shown without departing from the scope of this disclosure. In some alternative embodiments, the attachment tabs 110, 112, 114 may be omitted and the reflector 102 may be attached to the housing cover 106 using other means without departing from the scope of this disclosure. In some alternative embodiments, the attachment tabs 110, 112, 114 may have a different shape (e.g., shook or arrowed shape) than shown without departing from the scope of this disclosure. In some alternative embodiments, the wall section 108 may have a different shape than shown without departing from the scope of this disclosure. In some alternative embodiments, the top opening 402 and/or the bottom opening 222 may have a different shape than shown without departing from the scope of this disclosure. For example, the bottom opening 222 may have a rectangular shape.

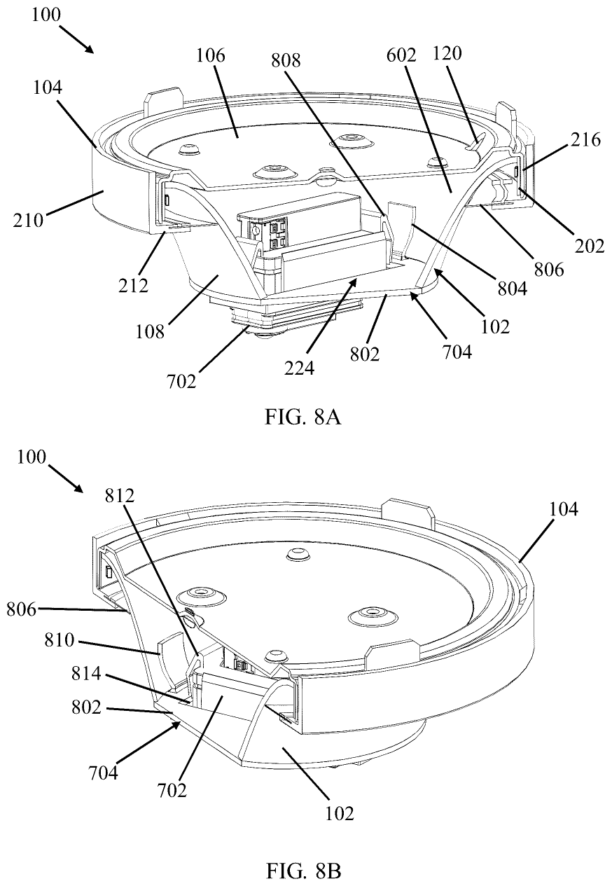

FIG. 7 illustrates a sensor device 702 attached to the light device 100 of FIG. 1 according to an example embodiment, and FIGS. 8A and 8B illustrate different cross-sectional views of the lighting device of FIG. 7 including the sensor device according to an example embodiment. Referring to FIGS. 1-8B, in some example embodiments, the lighting device 100 may include the sensor device 702 that is located at the bottom opening 222 of the reflector 102. The sensor device 702 may include an occupancy sensor and/or another sensor. The sensor device 702 may be attached to the reflector 102 by a mounting structure 704. The mounting structure 704 may include a plate 802 and spring clip arms 804, 810 that extend from the plate 802. The plate 802 may abut against the perimeter edge 406 of the reflector wall 108. For example, the sensor device 702 may be at least partially positioned in the reflector cavity 224. Alternatively, the sensor device 702 may be entirely in the reflector cavity 224 or entirely outside and below the reflector 102 at the bottom opening 222 of the reflector 102.

In some example embodiments, the sensor device 702 may extend through an opening 814 on the plate 802 and may be attached to the plate 802 by brackets 808, 812. For example, the brackets 808, 812 may be located across from each other. The spring clip arms 804, 810 may extend up and outwardly from the plate 802 such that the spring clip arms 804, 810 press against the reflector wall 108 of the reflector 102 from within the reflector cavity 224 to attach the mounting structure 704 to the reflector 102, thereby attaching the sensor device 702 to the reflector 102. For example, the spring clip arms 804, 810 may be in contact with the inner surface 602 of the reflector wall 108.

In some example embodiments, the lighting device 100 may include a lens 806 instead of the lens 208 shown in FIG. 2. In contrast to the lens 208 that extends vertically between the base section 212 of the housing frame 104, the lens 806 extends horizontally between the base section 212 and the reflector 102. As described above, the skirt section 216 of the housing cover 106 may be positioned on the base section 212 of the housing frame 104 and around the light source board 202. The wall section 210 of the housing frame 104 may be positioned around the skirt section 216 and thus around the light source board 202. Because the light source board 202 is positioned around the reflector 102 and outside the reflector cavity 224, the sensor device 702 can be located at the bottom opening 222 of the reflector 102 without interfering with the lights provided by the light source board 202. As such, the lighting device 100, which can be, for example, a surface mounted or recessed light fixture, can include the sensor device 702 as an integrated sensor device. Power may be provided to the light source board 202 and, if needed, to the sensor device 702 using an electrical cable that is routed through the wire routing opening 120 of the housing cover 106.

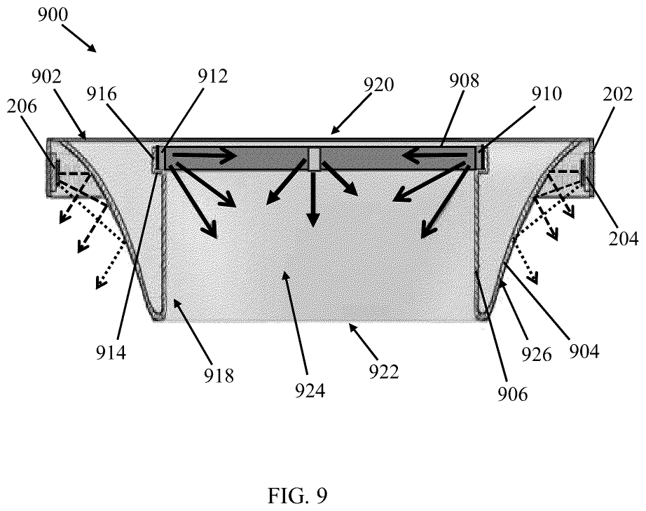

FIG. 9 illustrates a cross-sectional view of an assembly 900 of a reflector 902 and light source boards 202, 908 for use in the lighting device 100 of FIG. 1 according to an example embodiment. For example, the lighting device 100 of FIG. 1 may include the assembly 900 instead of the assembly 400 of FIGS. 4A-4C. That is, the lighting device of FIG. 1 may include the reflector 902 instead of the reflector 102 shown in FIGS. 6A and 6B.

In some example embodiments, the assembly 900 includes the reflector 902 having a reflector wall 904 and an inner wall 906. The inner wall section 906 may extend from the reflector wall 904 such that the reflector wall 904 is positioned around the inner wall 906. The reflector wall 904 may correspond to the reflector wall 108 of the reflector 102 shown, for example, in FIGS. 6A and 6B. The reflector wall 904 may extend between a top opening 920 of the reflector 902 and a bottom opening 922 of the reflector 102. For example, the reflector wall 904 may have a curved shape as the reflector wall 904 extends between the top opening 920 and the bottom opening 922. The reflector wall 904 may have a reflective outer surface corresponding to the reflective outer surface 122 of the reflector wall 904 of the reflector 102 shown, for example, in FIGS. 6A and 6B.

In some example embodiments, the inner wall 906 of the reflector 902 extends upwardly from the reflector wall 904 toward the top opening 920 of the reflector 902. For example, the reflector wall 904 and the inner wall 906 may be connected at the bottom opening 922. The inner wall 906 may extend upwardly (e.g., vertically, slanted, or curved) toward the top opening 920 of the reflector 902 as the reflector wall 904 is curved outwardly away from the inner wall 906 as the reflector wall 904 extends upwardly from the bottom opening 922.

In some example embodiments, the light source board 202 is positioned around the reflector 902. For example, the light source board 202 may be positioned proximal to the top opening 920 of the reflector 902. The light source board 202 may be positioned to provide lights directed toward the reflector wall 904 such that the lights are reflected downwardly by the reflector wall 904. For example, the light source board 202 may include the light sources 204, 206 as well as other light sources as shown, for example, in FIG. 4C. The light sources of the light source board 202 may be positioned to emit lights toward the reflective outer surface 926 of the reflector wall 904. The lights emitted by the light sources 204, 206 are illustratively shown in FIG. 9 as dotted arrows.

In some example embodiments, when the lighting device 100 of FIG. 1 includes the reflector 902 instead of the reflector 102, the light source board 202 may be attached to the skirt section 216 of the housing cover 106 in the described above with respect to FIG. 2. In some alternative embodiments, the reflector 902 may have a skirt that extends down at the perimeter edge 404 around the reflector wall 904, and the light source board 202 may be attached to skirt of the reflector wall 904, instead of the skirt section 216 of the housing cover 106, to provide lights that are reflected downwardly by the reflective outer surface of the reflector wall 904. In general, the light source board 202 may be positioned relative to the reflector 902 in the manner described with respect to the light source board 202 and the reflector 102 of FIG. 2, and the reflective outer surface of the reflector wall 904 may reflect the lights downwardly in the manner described with respect to the reflector wall 108 of the reflector 102.

In some example embodiments, the inner wall 906 includes a ledge section 914 and an attachment section 916. The ledge section 914 may extend toward the reflector wall 904 that surrounds the inner wall 906. The attachment section 916 may extend up from the ledge section 914, and the light source board 908 (i.e., the second light source board) may be attached to the attachment section 916 above the ledge section 914. For example, the light source board 908 may be attached to the attachment section 916 using an adhesive and/or one or more fasteners. The light source board 908 may be positioned proximal to the top opening 920 of the reflector. In general, the light source board 908 may be positioned such that lights provided by the light source board 908 exit the reflector 902 through the bottom opening 922 of the reflector 902.

In some example embodiments, the light source board 908 may include a printed circuit board and light sources (e.g., LED light sources) that are attached to the printed circuit board. For example, the light source board 908 may include light sources 910, 912 as well as other light sources that are positioned to emit lights into an inner wall cavity 924 surrounded by the inner wall 906. Some of the lights emitted by the light sources of the light source board 908 are illustratively shown in FIG. 9 as thick arrows. The lights emitted by the light sources of the light source board 908 may exit the inner wall cavity 924 of the reflector 902 through the bottom opening 922. Some of the lights emitted by the light sources of the light source board 908 may be reflected by an inner surface 918 of the inner wall 906 before exiting the inner wall cavity 924 through the bottom opening 922.

In some example embodiments, the light source boards 202, 908 may be controlled together or independently. For example, by controlling the light source boards 202, 908 independently, the lighting device 100 may be controlled to provide different light distribution patterns. To illustrate, the light source board 202 may be powered on while the light source board 908 is powered off or vice versa. Both light source boards 202, 908 may also be powered on to provide lights concurrently. By using the light source boards 202, 908, the need to change a reflector, a lens, or even an entire light fixture to achieve a different light intensity pattern may be avoided.

In some example embodiments, the reflector 902 may be made from a metal, such as aluminum, using one or more methods such as bending, cutting, welding, etc. The reflector 902 may be painted with a reflective color (e.g., white) such that the reflective outer surface of the reflector wall 904 and the inner surface of the inner wall 906 efficiently reflect lights. Alternatively, the reflector 902 may be made from another material, such as plastic, using one more or more methods such as injection molding. For example, the reflector 902 may be made from white plastic.

In some alternative embodiments, the light source board 202 may be at a different location (e.g., lower) than shown in FIG. 9 without departing from the scope of this disclosure. In some alternative embodiments, the light source board 908 may be at a different location (e.g., lower) than shown in FIG. 9 without departing from the scope of this disclosure. In some alternative embodiments, the ledge section 914 may be omitted without departing from the scope of this disclosure. In some alternative embodiments, the inner wall 906 may be curved or slanted without departing from the scope of this disclosure.

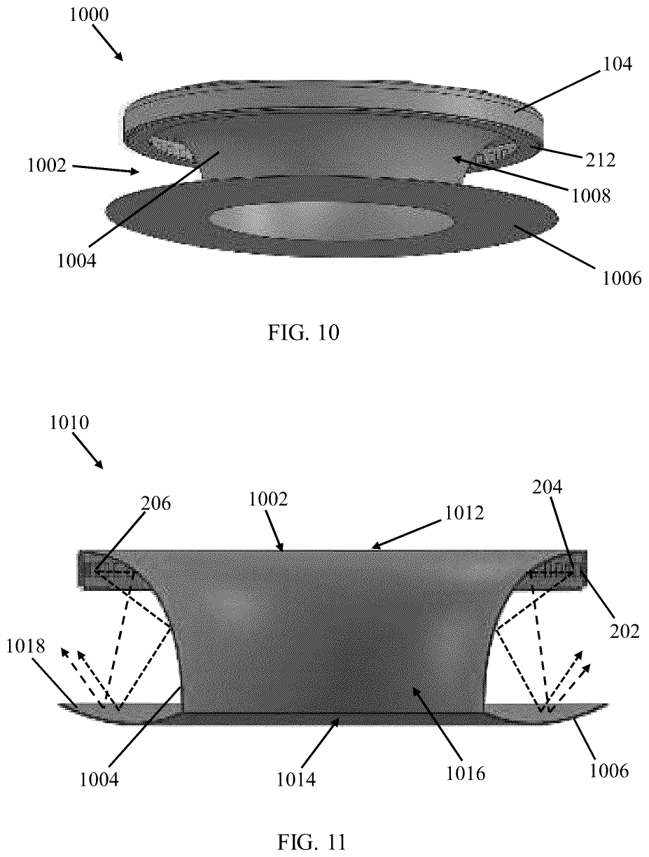

FIG. 10 illustrates a lighting device 1000 having a reflector 1002 according to another example embodiment, and FIG. 11 illustrates a cross-sectional view of an assembly 1010 of the reflector 1002 and the light source board 202 of the lighting device 1000 of FIG. 10 according to an example embodiment. In some example embodiments, the lighting device 1000 may include the housing frame 104 positioned around the reflector 1002 in the manner described with the housing frame 104 and the reflector 102 shown in FIG. 2. The housing frame 104 may be positioned around the reflector 1002 by slanting the housing frame 104 and stretching down the base section 212 of the base section 212 as needed. Although not shown in FIGS. 10 and 11, the lighting device 1000 may include the housing cover 106 (shown in FIGS. 1 and 2) positioned on the housing frame 104 in the manner described with respect to the lighting device 100 and FIGS. 1 and 2.

In some example embodiments, the reflector 1002 includes a reflector wall 1004 that has a reflective surface 1008. For example, the reflector wall 1004 may correspond to the reflector wall 108 of the reflector 102 shown in FIGS. 1 and 2. The reflector wall 1004 may surround a reflector cavity 1016. The reflector wall 1004 may extend between a top opening 1012 of the reflector 1002 and a bottom opening 1014 of the reflector 1002. For example, the reflector wall 1004 may have a curved shape as the reflector wall 1004 extends between the top opening 1012 and the bottom opening 1014, where the bottom opening 1014 is smaller in size (e.g., smaller diameter) than the top opening 1012. The reflector 1002 may also include a flange section 1006 that extends outwardly from the reflector wall 1004 at the bottom opening 1014 of the reflector 1002.

In some example embodiments, the lighting device 1000 may include the light source board 202 that is positioned around the reflector wall 1004. The light source board 202 may include light sources including light sources 204, 206, 408, 410, 412, 414, 416, 418 (as shown in FIGS. 4B and 4C). The light source board 202 may be positioned around the reflector wall 1004 proximal to the top opening 1012 of the reflector 1002. The light source board 202 may be positioned such that the lights emitted by the light sources of the light source board 202 are directed toward the reflector wall 1004. The reflective outer surface 1008 of the reflector wall 1004 may reflect downwardly the lights emitted by the light sources of the light source board 202.

In some example embodiments, the reflector 1002 may include a flange section 1006 that extends outwardly from the reflector wall 1004 at the bottom opening 1014 of the reflector 1002. The flange section 1006 may have a reflective back surface 1018. The flange section 1006 may have a curved shape as the flange section 1006 extends outwardly from the reflector wall 1004. The flange section 1006 may extend outwardly from the reflector wall 1004 such that the flange section 1006 upwardly and outwardly reflects the lights emitted by the light sources of the light source board 202 and reflected down by the reflective outer surface 1008 of the reflector wall 1004. In general, the flange section 1006 may be positioned and shaped such that the reflective back surface 1018 reflects, upwardly and outwardly, the lights reflected down by the reflective outer surface 1008. As such, the lighting device 1000 can provide an indirect light to a space such as a room and may serve as indirect light luminaire. For example, the lighting device 1000 may be installed partially recessed in a ceiling where the flange section 1006 is spaced from the ceiling such that the lights reflected by the flange section illuminate the ceiling from below. The lights that are emitted by the light sources 204, 206 of the light source board 202, reflected down by reflective outer surface 1008, and reflected upwardly and outwardly by the flange section 1006 are illustratively shown in FIG. 11 as dotted arrows.

In some example embodiments, the reflector 1002 may be made from a metal, such as aluminum, using one or more methods such as bending, cutting, welding, etc. The reflector 1002 may be painted with a reflective color (e.g., white) such that the reflective outer surface 1008 of the reflector wall 1004 and the reflective back surface 1018 of the flange section 1006 efficiently reflect lights. Alternatively, the reflector 1002 may be made from another material, such as plastic, using one more or more methods such as injection molding. For example, the reflector 1002 may be made from white plastic.

In some alternative embodiments, the lighting device 1000 may have a different shape than shown without departing from the scope of this disclosure. For example, the housing frame 104 may have a different shape than shown. To illustrate, the housing frame 104 may have a rectangular shape instead of a round shape. In some example embodiments, the reflector wall 1004 may have a different shape than shown without departing from the scope of this disclosure. For example, the reflector wall 1004 may be curved more or less than shown. As another example, the reflector wall 1004 may not be curved. In some alternative embodiments, the light source board 202 may be angled toward or away from the reflector wall 1004 without departing from the scope of this disclosure. In some alternative embodiments, the light source board 202 may be at a different location (e.g., lower) than shown in FIG. 11 without departing from the scope of this disclosure. In some alternative embodiments, the lighting device 1000 may include the lens 208 shown in FIG. 2 or the lens 806 shown in FIG. 8A without departing from the scope of this disclosure. In some alternative embodiments, the reflector wall 1004 may have a different shape than shown without departing from the scope of this disclosure. In some alternative embodiments, the top opening 1012 and/or the bottom opening 1014 may have a different shape than shown without departing from the scope of this disclosure. For example, the bottom opening 1014 may have a rectangular shape. In some alternative embodiments, the lighting device 100 may include other components such as a driver, the sensor device 702, and/or mounting structures that may be used to mount the lighting device 1000, for example, partially recessed in a ceiling.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the scope of the following claims, the scope of which are to be accorded the broadest interpretation so as to encompass modifications and equivalent structures.

1. A lighting device, comprising:
a reflector comprising a reflector wall surrounding a reflector cavity, the reflector wall having a reflective outer surface, wherein the reflector wall extends between a top opening of the reflector and a bottom opening of the reflector and wherein the bottom opening is smaller than the top opening;
a light source board comprising light sources, wherein the light source board is positioned around the reflector, wherein the light source board is oriented such that the light sources emit lights toward the reflective outer surface, and wherein the reflector wall is shaped such that the reflective outer surface reflects the lights downwardly away from the light source board;
a second light source board comprising second light sources, wherein the reflector further comprises an inner wall that extends from the reflector wall such that the reflector wall is positioned around the inner wall and wherein the second light source board is positioned such that second lights emitted by the second light sources exit the reflector through the bottom opening; and
wherein the inner wall includes a ledge section and an attachment section, wherein the ledge section extends toward the reflector wall, wherein the attachment section extends up from the ledge section, and wherein the second light source board is attached to the attachment section above the ledge section.

2. The lighting device of claim 1, wherein the reflector wall has a curved shape between the top opening of the reflector and the bottom opening of the reflector.

3. The lighting device of claim 1, further comprising a housing frame having a wall section and a base section, wherein the wall section is positioned around the light source board and wherein the base section extends from the wall section toward the reflector such that the base section hides the light sources from view from directly below the light sources.

4. The lighting device of claim 3, further comprising a housing cover having a cover section and a skirt section that extends down from the cover section, wherein the skirt section is positioned around the light source board between the light source board and the wall section.

5. The light device of claim 4, wherein the reflector comprises attachment tabs that extend up from the reflector wall into respective slots of the top cover to attach the reflector to the top cover.

6. The lighting device of claim 3, further comprising a lens positioned vertically between the base section and the reflector wall.

7. The lighting device of claim 3, further comprising a lens positioned horizontally between the base section and the reflector wall.

8. The lighting device of claim 3, wherein the light source board is positioned around the reflector proximal to the top opening of the reflector.

9. The lighting device of claim 1, further comprising a sensor device positioned at the lower opening of the reflector.

10. The lighting device of claim 9, wherein the sensor device is attached to the reflector by a mounting structure that comprises a plate and spring clip arms that extend from the plate, wherein the spring clip arms press against the reflector wall from within the reflector cavity to attach the mounting structure to the reflector, and wherein the sensor device is attached to the plate.

11. The lighting device of claim 9, wherein the sensor device is at least partially positioned in the reflector cavity.

12. (canceled)

13. (canceled)

14. The lighting device of claim 1, wherein the reflector further comprises a flange section that extends outwardly from the reflector wall such that the flange section reflects upwardly and outwardly the lights emitted by the light sources and reflected down by the reflective outer surface of the reflector wall.

15. The lighting device of claim 14, wherein the flange section has a curved shape as the flange section extends outwardly from the reflector wall at the bottom opening of the reflector.
